(19) United States
(12) Patent Application Publication
(10) Pub. No.: US 2003/0036042 A1
(43) Pub. Date: Feb. 20, 2003

(54) Method for programming the mind to follow a behavior plan

(76) Inventor: Deborah LaDon Hill, Sunland, CA (US)

Correspondence Address: Deborah LaDon Hill, 7978 Glenties Lane, Sunland, CA, 91040, US

(21) Appl. No.: 10/222,321

(22) Filed: Aug. 16, 2002

Related U.S. Application Data
(60) Provisional application No. 60/313,339, filed on Aug. 17, 2001.

(51) Int. Cl. G09B 19/00

(52) U.S. Cl. 434/236; 434/238

(57) ABSTRACT

A method of teaching an individual to program their mind to follow a voluntary personal behavior plan that helps to achieve a predetermined goal. Provides a set of rules (3) and techniques (7) that the individual uses to select and follow a personal behavior plan. Instructs the individual to make a promise (4, 5) to follow the selected behavior plan. A means of incentive (3, 6) is provided for the individual to keep the promise that helps them withstand considerable temptations to do otherwise. Whereby, when the individual makes the promise to follow the behavior plan, they can reach and maintain a state of mind in which they fully intend to follow the plan, which programs or alters activities of their mind and body to help succeed in following the plan and reach the predetermined goal (18).

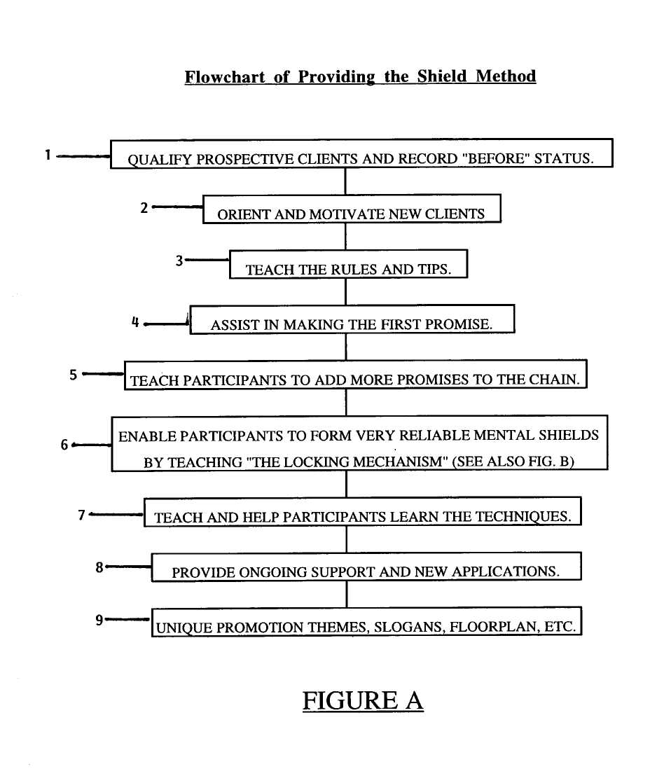

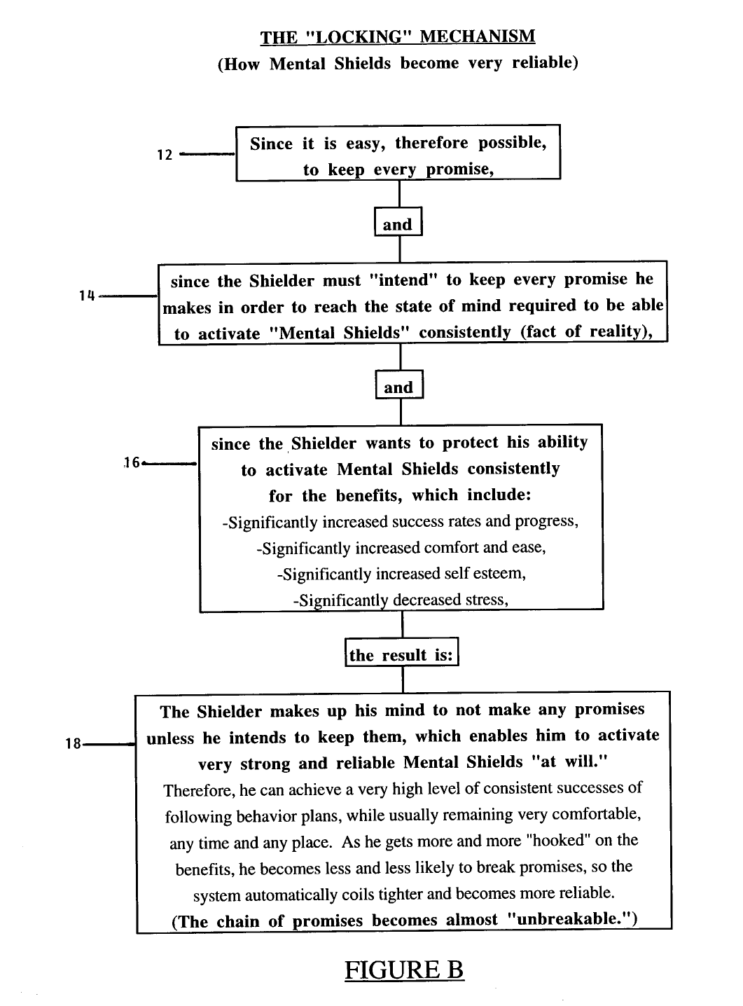

### BACKGROUND

1. Field of Invention

This invention relates to a business method of helping people increase their levels of success at performing desired behaviors.

2. Description of Prior Art

People need to be able to follow self improvement plans in order to reach personal goals, such as to lose weight, stop smoking, stop drug or alcohol abuse, tone muscles, etc. But most of the prior art assumes that people already have enough personal control or willpower to stick to a plan and get the results they want. We are simply told, “Follow this plan or method and you will lose weight, get 6-pack abs, quit smoking, etc.” These programs often attempt to fortify our willpower with motivation, education, support (counseling or computer enhanced interactive programs), drugs, etc. Nevertheless, very few people have the personal control required to stick to their self improvement plans long enough to achieve and/or maintain the results they desire. Long-term success rates of even 3% are rare in the fields of self control.

These low success rates are well documented in the area of weight control. The Washington Post reported that only one individual out of every 200 who go on a diet will lose all the weight they set out to and keep it off for any reasonable length of time. That's a 99.5% long-term failure rate! Most studies report that less than 10% of dieters can maintain even a 5% loss from initial body weight for 5 years. For example, of those who start at 250 pounds, less than 10% can maintain a loss of even 12.5 pounds! Of those who start at 150 pounds, less than 10% can maintain a loss of even 7.5 pounds!

According to the “Merck Manual of Medical Information” (C) 1997, “The prevalence of obesity in the United States is only increasing—up 33 percent in the past decade alone.”Very often, people gain all the weight back, plus “a little more” each time they diet, and it becomes more difficult for them to start and succeed each time they try because of physiological and psychological complications. The need for a solution to obesity is so great that the Surgeon General recently announced that it is at an all time crisis and a solution needs to be found!

Similarly low success rates plague methods for other types of self improvement. For example, the majority of people who join gyms or buy exercise equipment don't use them for more than a few weeks. Success at treating drug and alcohol addiction is in similar crisis.

The problem with most of the above methods is that they ultimately depend on willpower, which is often inadequately strong and inconsistent. Willpower may work fine when temptations and urges to go off of a resolved personal plan are weak, but it usually can't withstand strong temptations and urges for very long. Unfortunately, for most people temptations and urges eventually become very strong, and all the progress they can make when their willpower is strong can easily be made up for, and more, when it fails.

Once a strong desire or temptation has been “kindled,” a person must “fight” their mind as it sends thoughts and desires for them to “go off” their plan and have (or do) what they really want. The mind is extremely skillful at getting people to “give in” to their strong desires. It works by:

sending mental pictures of having the desire into the person's consciousness,

sending pleasant memories of what it is like to be able to eat or do what they want,

altering moods to make the person feel that they can't “accept” doing without the desire,

making the 5 senses more sensitive to signals for the desire (being sure the person “sees” opportunities to have it, “smells” the baking bread they're not supposed to have, is more sensitive to the “taste” and “tactile sense” of it, “hears” everyone else leave for pizza that they can't have, etc.

sending ideas and plans of how to get the desire to their consciousness,

sending ideas of rationalizations into their consciousness,

altering known and unknown chemicals and nerves within the brain and body that assist in obtaining the desire,

increasing the desire, etc.

Willpower is a relatively easy “obstacle” for the human mind to overcome to get people to give in to their strong desires. In fact, who knows a person better than their own mind? It knows just the right rationalizations they will “buy” and give in to. It knows just the right moods to put them in and the best plans and ideas to send into their consciousness to tempt them off their plan. The human brain is so successful in obtaining strong desires, in fact, that it's almost futile to try to fight it, as current success rates bear out. It can be very stressful to try to resist.

Prior art methods which have attempted to decrease reliance on willpower, or fortify it, have similarly low success rates and disadvantages. For example, according to the above Merck Manual reference, concerning the use of prescription drugs, “Generally, such a drug reduces weight by about 10 percent within 6 months and maintains the loss as long as the drug is continued. When it's discontinued, the weight is promptly regained.” These drugs also carry substantial side-effect risks, which is why their use must be prescribed and closely monitored by a physician. According to the same reference, doctors are even leaning against medically supervised methods of using very low calorie diets, with or without injections of pregnant women's urine (as was frequently prescribed in the recent past), because studies have shown that “. . . people tend to regain weight after going off the diet.”

Surgery, to remove part of the intestine, is becoming the medical treatment of choice for persons with severe obesity. According to the above reference, it usually results in rapid weight loss at first, which gradually slows over 2 years. This method is impractical for most people because it carries so many serious health risks that it is usually reserved only for those who are more than 100% overweight. It is also very costly. Food blockers (such as fat or carbohydrate blockers) have not worked because people usually just compensate by eating more, like they did with the advent of saccharin.

Low success rates persist, despite positive reinforcement (or feedback) systems, such as U.S. Pat. No. #5,954,510: Interactive Goal-achievement System and Method, and U.S. Pat. No. #5,697,790: Discipline System); negative reinforcement (or feedback) systems, such as pain-induced electrical punishment system applied to the skin while the patient engages in undesirable behaviors and is told of their negative qualities, like “The Schick Method.”; behavior modification techniques, (such as U.S. Pat. No. #5,207,580: Tailored Health-related Behavior Change and Adherence Aid System); and goal setting techniques, such as U.S. Pat. No. #5,954,510 “Interactive Goal-achievement system and method.”

Repeating subliminal messages or positive affirmations have been shown to be highly ineffective ways of improving behavior in both the short and long-term. Special food combinations and nutritional approaches (such as the low carbohydrate or low fat diet) do not give superior results, since people often start experiencing extremely strong cravings for the food combinations that they prefer, and discontinue. People on low carbohydrate diets, in particular, may also not get the important recommended daily allowances of fruits and vegetables, or get too much animal protein and fat, both of which are associated with increased rates of cancer and other serious diseases. (A single apple has all the carbohydrates many low carbohydrate diets may allow in a day.)

Hypnosis and mental imaging have very low success rates. Physical barriers have been tried, such as wiring a person's teeth shut or having them stay at a clinic or retreat to limit caloric intake or improve other behaviors. These types of methods are not a practical way to live, don't really change behaviors and their success rates are very low. When the person is “released” they usually fall back on old habits and make up for any progress made. Removing temptations from one's environment has not decreased the need for personal control, since tempting foods are almost always available or obtainable in today's society. Bulimia (vomiting), taking diuretics or other methods which people have been used to expel ingested food also pose health risks and are associated with psychosis.

Methods which attempt to improve habits, such as behavior modification programs, have obtained dismal results. In fact, the prior art warns how difficult it is to change habits (and how easy it is to fall back on old habits and even gain new bad habits) and suggests that people are only likely to succeed if they try to make small, easy changes. However, the current consensus is that habits must be changed in order to achieve lasting results at weight loss and other behavior goals.

Methods which utilize appointments, support and education have also obtained poor results. These include counseling, support groups, highly charged motivational meetings, personal trainers etc. They work best when they stress the negative aspects of the undesirable habits, educate about preferable ones and give motivation, such as U.S. Pat. No. #4,344,625: Game Encouraging Self-Improvement. However, results have still been inconsistent and very disappointing. Just knowing that a certain behavior is better does not mean that a person will choose it. Healthier foods are more time consuming to prepare. Low fat foods don't taste as good and aren't as satisfying as the fast, easy, high caloric foods that are constantly advertised to consumers. Companies that produce low fat foods are saying that people have been turning away from their products and buying foods that taste better. People who hire expensive personal trainers for support often find scheduling inconvenient or are embarrassed to sweat and grunt in front of them and cancel further appointments.

In summary, we have been losing the battle for self control!

### OBJECTS AND ADVANTAGES

My invention is a method of teaching people to activate and effectively use what I have termed “Mental Shields.” These Mental Shields program the mind to work “for” an individual's behavior plan, rather than “against” it. They ensure a very high rate of success in helping people follow a behavior plan and can enable most people to withstand strong temptations and urges to do otherwise. Therefore, my invention overcomes two major problems of the prior art (low success rates and inability to withstand strong temptations to stick to a behavior plan). Using Mental Shields with the rules and techniques I have developed as part of this invention can give people so much more personal control that it is as if they have “super” willpower.

To my knowledge, there has never been an effective or practical means of enabling people to use this ability of the mind for personal control applications. Indeed, this was presumed to be impossible. I believe this invention is the first method to date that can help a majority of people easily and quickly establish new habits, and it may be the first true cure for “Binge Eating Disorder” (B.E.D.). It can significantly increase an individual's ability to succeed at personal goals, while also significantly decreasing their levels of stress.

Some additional objects and advantages of this method are:

(a) It can decrease the number and severity of temptations and urges to do other than a person's specifically planned behavior intentions.

(b) In addition to enabling people to withstand strong temptations and urges to do other than their specifically planned behavior intentions, it can make it easier for them to resist mild to moderate temptations and urges to do so.

(c) It can significantly reduce the need to expend energies required to maintain willpower.

(d) It can make people much more comfortable while performing specifically planned behaviors intentions.

(e) It can significantly increase people's ability to control their behaviors.

(f) It can significantly increase people's confidence in their ability to control their behaviors and achieve their goals.

(g) It can significantly increase people's self esteem and sense of accomplishment.

(h) It can make it easier for people to resist strong temptations and urges to do other than their specifically planned behavior intentions.

(i) It can be relied upon to work almost any time and any place.

(j) It can deflect urges and temptations to do other than a person's specifically planned behavior intentions (so that they are decreased or eliminated).

(k) It can enable people to be able to quickly regain control if they start to lose it, such as when a binge begins.

(l) It can improve habits, even permanently.

(m) It can help establish new habits that are preferred over old habits.

(n) It can improve health (by helping people achieve goals in areas of weight loss, exercise, control of alcohol consumption, etc.).

(o) It can be used to control almost any behavior (“do” behaviors, such as “do exercise” as well as “don't” behaviors, such as “don't” eat a second helping).

(p) It provides a method for obtaining personal goals that not only reduces stress, but is as enjoyable, exhilarating and fun as a game. This enables people to be able to stay on it indefinitely for consistent progress.

(q) It can often eliminate the need for risky, invasive methods of personal control.

(r) It significantly reduces major setbacks in progress.

(s) It can enable many weight loss programs that have not worked to work now.

(t) The preferred method of delivery also provides personal analysis, teaching, training, guidance, support, motivation and new applications for use of the Shield Method.

Further objects and advantages of my invention will become apparent from a consideration of the flowcharts and ensuing description.

### SUMMARY

This invention provides a method that overcomes at least 2 major problem of the prior art, by providing a means for self control that is capable of withstanding strong urges and desires to do other than a person's specifically planned behaviors and achieving a high degree of success in keeping them. Therefore, it provides an improved method of achieving personal control.

### DRAWING FigureS

Figure A. This is a flowchart of the steps involved in helping people learn and use the Shield Method and of providing support and unique business and promotion the Methods.

Figure B. This is a diagram of the “locking” mechanism, or how Mental Shields become more and more reliable.

### DETAILED DESCRIPTION, OPERATION & ADVANTAGES OF THE INVENTION

I have named this method of activating and using Mental Shields “The Shield Method.” To help describe the Shield Method, we use words based on “shield,” in various ways as nouns, verbs, etc., like “Shielder,” “shielded” and “shielding.” For example, we refer to people who use the Shield Method as “Shielders” and when a Shielder activates a Mental Shield, we say that they are “Shielded.”

The following description is a preferred embodiment for weight control, although the method may also be used for almost any other personal control applications as well, with or without modifications. Without being taught any modifications, Shielders often automatically use this method of activating Mental Shields to control other personal behaviors, such as to stop smoking, control drug and alcohol consumption, follow exercise programs, etc. Many more alternative uses are listed in the “Conclusions, Ramifications and Scope.”

The preferred embodiment is to have the individual come into an office or clinic for appointments and learn through the use of lessons and support group meetings for the additional support that this format provides. However, the program could be taught in almost any other format: book, home-study course, computer program, video or audio tapes, seminar, etc. Support is highly recommended and could also be given in many other ways (by interactive computer program, telephone calls, scheduled messages, FAX, on-line support groups, meetings, computerized or manual support system, etc.).

THE OVERALL GOAL OF THIS INVENTION IS TO HELP PEOPLE LEARN TO FORM AND EFFECTIVELY USE A CHAIN (OR SUCCESSION) OF MENTAL BEHAVIOR PROMISES (OR INTENTIONS) IN SUCH A WAY THAT A MENTAL SHIELD WILL BE ACTIVATED WHENEVER THEY ADD A PROMISE TO THE CHAIN. When a Mental Shield is activated, this will effectively program their mind to follow the behavior they have promised, altering activities of their mind and body to help them follow the behavior plan with a very high degree of success.

The steps of teaching people to create and use this chain of promises are outlined in Figure A. These steps are described below but are not required to be given in the exact order.

Figure A, #1: Qualify prospective clients and record “before” status. This is accomplished by collecting information about their current habits, current levels of control and motivation and goals. If they are found to be good candidates, payment arrangements are made. We may then complete a more detailed “before status” analysis (of current habits, goals, physical status, etc.) before proceeding to the next step.

Figure A. #2: Orient and motivate new clients. We teach new clients what Mental Shields are, more specifically, and the benefits that the Shield Method can offer them. We inform them of what to expect and what is required of them, regarding attendance, etc. A preferred embodiment is 12 weekly individual learning and evaluation appointments followed by weekly support group meetings, as needed or desired. We verify that new clients understand essential information by testing or through the use of an interactive computerized format. The following is an example of an orientation description that we may provide:

### What are Mental Shields?

Mental Shields are activated by the mind whenever we feel “absolutely sure” that we can't have desires. They make us comfortable without the things we can't have. For example when we are in a restaurant waiting for a table and see food on a stranger's plate, no matter how appealing their food is or how hungry we happen to be, we feel “absolutely sure” that we can't walk over and take the stranger's food. This is the mental state required to activate a Mental Shield, so we are “Shielded.”

When Shielded, our mind won't work to obtain that food desire for us. In fact, it will be programmed to make us comfortable without the other person's food and even sort of “blind” to it (we can see it but in a different, non-pursual way). This example illustrates the high success and comfort rates of Mental Shields. They are usually more than 99% effective at protecting behaviors while usually making us comfortable.

This is an example of a permanent “Social Shield,” not a “Personal Behavior Shield” (PBS) that the Shield Method teaches people to activate. When an over-eater is home, they're likely to eat anything and everything they want because they are not protected by a Behavior Shield at home.

The Shield Method enables people to activate very reliable, very strong Personal Behavior Shields “at will.” This can give them the same kind of protection and comfort at home or anywhere else. I have named this method the “Shield Method,” because the Mental Shields we teach people to form “Shield” them from behavior failure and the discomfort of having to fight their minds.

Learning the Shield Method is like learning the rules and techniques of a game. The ordinary steps produce an utterly unexpected, extraordinary result. The individual follows the rules and they work instantly, without having to practice, although practicing the techniques of using them will increase their skill and ease of obtaining goals. In a preferred embodiment, Shielders learn by attending individual appointments and support-group meetings. Time is allowed between appointments for practice and to let the information sink in. The Shield Method can dramatically improve personal control and can be used to obtain many personal goals, such as weight loss and to exercise consistently without a personal trainer, etc.

### Additional information about Mental Shields:

Since these concepts of “Mental Shielding” are unknown at this time, scientific evidence of the existence and effectiveness of Mental Shields is indicated and included here for the reader:

“Mental Shielding” may be described in the psychological terms of the id, the ego and the superego, the three divisions of the mind or “psyche.”

The id is the primitive mind (instinctual drives).

The superego represents the moral standards and ethics that you believe in. It rewards you with good feelings about yourself when you meet these standards, and makes you feel bad when you don't.

The ego mediates between the above 2 divisions of the mind. According to Taber's Encyclopedic Medical Dictionary, “The ego possesses consciousness and memory and serves to mediate between the primitive instinctual or animal drives (the id), internal social prohibitions (the superego), and reality. Thus the ego allows one to adapt to what might otherwise be a very unpleasant situation. The psychiatric use of the term should not be confused with its common usage in the sense of ‘self-love’ or ‘selfishness.’”

To clarify, think of the above example of being in a restaurant: When you are very hungry and want to eat (a primitive id desire), but feel “absolutely sure” that you can't take a stranger's food (because of a strong social superego influence), your ego will form a Mental Shield to protect you from the id desire, so that it is very easy and comfortable for you to be able to resist the stranger's food. If the mind couldn't do this, we couldn't adapt when it is not possible to have things that we want, and this would be “very unpleasant,” as the above Tabor's definition describes.

My theory for how the Shield Method works is that it enables people to create a new, very strong superego influence, so that they can activate the natural “Shielding” ability of their egos. Or it may be the ego activating a protective mechanism as it does whenever a person cannot have a desire. Regardless, whenever a person attains the required state of mind, we have noticed that a Mental Shield always forms, in keeping with the Scientific Method. (Except in neuroses, when instinctual drives are in conflict with those dictated by the superego.)

The action and benefit of Mental Shields are that they actually “reverse” the activity of the mind. They stop the mind from working “for” desires that we can't have and put the mind to work to help us succeed at resisting them. As in the above example, when we feel that can't take food from a stranger's plate (even though we could), a protective Mental Shield will be activated. Then our mind will not work to send ideas, thoughts, plans, rationalizations, etc. into our consciousness of taking the other person's food. Instead, it will do everything in it's power to suppress these thoughts and help make us comfortable without the other person's food. It's so good at this that it is as if we are “blind” to the other person's food, in a pursual way. The actions of the mind to help us comfortably succeed can be mental, neuronal, chemical, physical and/or biological. As Pavlov's experiments with dogs, and countless other experiments have since proved, our minds affect all of these systems.

I have found that the possibility to have an “id” desire must be utterly and completely eliminated in a person's mind for their ego to be able to form and maintain a reliable Mental Shield. This is why it was never possible to activate the “Shielding” ability of the mind for weight loss (and other personal control applications) before. How could the possibility to have excess food be eliminated, when food is everywhere around us or so easily obtainable in today's society? The only previous way was to physically lock a person up, and this is not an effective or practical or desirable way to live! My invention eliminates the real possibility to have desires in the person's mind, which is the way many Mental Shields work. For the first time, this Mental Shielding ability can enable people to comfortably and successfully “pass up” short-term desires (like tempting foods) so that they can achieve their long-term desires (like weight loss).

Mental Shields are perfectly safe because they utilize the way the mind naturally works. In fact, “Naturally Thin Eaters” have permanent Mental Shields which enable them stay thin comfortably and successfully. The only time an over-eater can experience what this is like is when they start a diet. Then, a temporary Mental Shield usually “materializes,” and helps them sail by the donuts and other tempting foods without even pursually “seeing” them. But diet Shields are only temporary. Sooner or later they disintegrate, and the dieter starts feeling uncomfortable and stressed because the id portion of the mind starts working for their habitual food desires. There has never been a way for dieters to maintain the state of mind that makes it easy and effortless before.

We all have and use Mental Shields in many areas of our lives (credit Shields, morality Shields, social Shields, physical Shields, etc.). Mental Shields are what allow us to be civilized, rather than primitive, and to progress. They are how we can enjoy eating in social situations, like restaurants, without fighting over food like packs of wild animals. They are how we can live together in peace. They create safeguards for advanced societies so that we can protect the things that are important to us.

We wouldn't even be able to drive safely without “Mental Driving Shields.” When you get behind the wheel of a car, you feel absolutely sure that you can't make a serious driving mistake, and this is the state of mind required to Shield you for driving behavior. Then, incredibly, you can cruise comfortably down freeways at high speeds, within a few feet of 18 wheelers and other vehicles for hours at a time—and not make a single serious mistake, well over 99.9% of the time! Reality and society have successfully established Mental Shields for all these advanced, civilized behaviors—just not for many personal ones, like resisting too much tempting foods. (How many “eating accidents” or “diet crashes” do over-eaters have every day?)

When a person is not Shielded from a desire and their mind is working for it, we say that they are “Shielded for” the desire. When Shielded for a desire, a person may not listen to reason, because their mind will exaggerate the positive aspects of the desire and try to block out or selectively ignore the negatives. Sometimes only after the person obtains the desire will they be released from the Shield and able to clearly see the negative aspects of having the desire. As the saying goes, “Be careful what you wish for because you may get it and then realized you don't really want it.”

Mental Shields give incredible advantages and should be highly valued and protected because they allow us to surely and easily resist primitive desires. For example, a person with an honesty Shield in a specific situation will be able to effortlessly return a wallet full of money that they find. It can be mentally painful and even impossible for a person without an honesty Shield for the same situation to resist the desire to keep the money. We all have a “Shield threshold” in the amount of pressure our Mental Shields can take. For example, under certain circumstances, almost any one's morality Shield can be strained to the breaking point and they will commit murder (called “breaking” a Shield). Shields can be permanent or temporary.

We have not been able to create the state of mind required to activate Personal Shields “at will” before. We have had to live with whatever Personal Shields our parents or life experiences gave us. The prior art describes that it is very difficult to change the contents of our superego so that we can permanently change habits. The Shield Method finally gives us a way to activate Mental Shields “at will” and even help to develop new permanent Mental Shields that we may desire.

Figure A, #3: Teach the rules and tips. In this step, we prepare the person to form their chain of promises by teaching them the rules for making promises:

### Rules and Tips for Making Behavior Promises

1. Promises must be easy, safe and short-term (from less than 1 minute to no more than 6 hours in the beginning). This is to make it easy for Shielders to keep all of their promises.

Tip: Some good promises for beginners include:

“I promise to only have ½ cup of mashed potatoes with dinner.”

“I promise not to eat anything for 1 hour.”

“I promise to only have 1 cup of soup and nothing else until dinner.”

“I promise not to eat after dinner for at least 3 hours.”

“I promise to not have any more than 2 pieces of pizza for dinner.”

Note: Longer-term promises may be allowed for certain behaviors, such as promising to attend appointments, etc.

2. Shielders can make promises at any time, more than one promises at a time, extend promises, make overlapping promises and can upgrade promises. (An example of an upgraded promise is promising to have no more than 3 cookies for an hour, and then upgrading the food to something more healthy of equal or lesser value, like 1 apple instead.)

3. Shielders are completely free to have anything they want after keeping their promises, unless an extended or overlapping promise is in effect. For example, if a Shielder promises not to eat anything for an hour, after the hour is over they are completely free and may have anything they want, unless another promise is still in effect. Note: We have found that the techniques of the Shield Method (Figure A, #7) are very effective in preventing Shielders from losing control and overeating after their promises are over.

4. Promises usually have a length of time assigned to them, but they don't have to have an exact time. For example, a Shielders can make the promise, “no more eating until I sit down with the family for dinner.”

5. A Shielder is not bound to keep any promise that is or becomes unsafe or unhealthy to keep.

6. “Shielders” can't make promises that they don't want to make. Note: The teaching and training process of the preferred in-office embodiment of the Shield Method is very effective in motivating most Shielders to make many promises consistently.

7. Shielders don't have to make any promise, but once they do, they are responsible to keep them. If they break any promise, they have to pay the following penalties.

a. The immediate “rule” consequence of breaking a promise is loss of “Shielding privileges” for 24 hours (the forfeiture of the right to add any promises to their chain for 24 hours). The purpose of this rule is to give an immediate penalty and also to help the Shielder value the ability to use his Shield any time at will.

b. The long-term consequence of habitually breaking promises is that they will lose all benefits of the Shield Method, since their ability to activate Mental Shields will deteriorate (as further described in Figure A, #6.)

8. Shielders are not held responsible if they “innocently” break a promise (such as when they forget they had made a promise), although they must take steps to remember their promises if it happens often (this doesn't happen to most Shielders very often).

9. When a Shielder is in the “act” of “innocently” breaking a promise, they do not have to stop instantly. We have found that the mind is so strong that you can't just stop eating a cookie that you forgot you had promises not to eat and spit it out immediately when you suddenly realize that you weren't supposed to have it. Few Mental Shields are so strong that they can withstand the full, infinite power of the mind instantaneously. The mind will “break” the Shield (make the person break the promise)! So we allow the Shielder to make a follow-up promise at times like this, such as “Just 1 or two more bites.” Without this rule, Shielders would unnecessarily and innocently break their chain of promises.

Step #3 may come before or after this point. For example, we may guide the individual to make their first promise(s) while learning the rules. The rules may be altered, according to what works best for each individual and each behavior goal. For example, it may be determined that a different length of promise is better for certain goals or custom penalties for breaking promises may be helpful for certain individuals.

Figure A, #4: Assist in making the first promise: To initiate their chain of promises, we instruct the individual to mentally decide on a first promise, in accordance with the above rules and any tips or suggestions that we have provided. Then we instruct them to mentally make the promise that they have decided on.

Additionally, we have found it most helpful to instruct participants to use a “physical activation signal,” when making promises. For example, we tell them that after they decide on a promise to tap the thumb and middle finger of one hand together 3 times to “seal” the promise to their chain of promises. This is very effective in helping to distinguish between promises they just “thought about making” and promise they have “actually made.” Any physical signal could be used, but this one works particularly well for most people. It can be used very discretely any time and any place to “seal” additional promises to the chain. After awhile, the signal may actually play a roll in activating Mental Shields, since it is often the moment that the person becomes “absolutely sure” that they will keep their promise. However, it does not, in itself, activate a Shield. Only the state of mind of being “absolutely sure” that a person will keep his promise can activate and sustain a Mental Shield.

By making their first promise, the participant has initiated his chain of promises. We teach them that a Mental Shield may then “materialize,” to help them keep their promise, but only if and as long as they feel “absolutely sure” that they won't break the promise. We remind them that it is very easy to keep their promise and encourage them to keep their mind made up to keep their promise so they can experience what it feels like to be “Shielded.”

Figure A, #5: Teach participants to add more promises to the chain. Now we instruct the individual to add more promises to their chain of behavior promises by making promises in the same manner that they made their first promise. Again, we may inform them that Shields may materialize to help them keep their promises, but only if and as long as they feel “absolutely sure” that they won't break them. We remind them that it is easy to keep all of their promises and encourage them to keep their mind made up to keep all of their promises. We may also inform them that these Shields are not yet reliable (they are really only keeping them because they “want” to at this point) and assure them that they will later learn how to make them very reliable (in Figure A, #6). The reason that it is helpful to have them make unreliable Shields at first is that it helps them experience the benefits of Shielding. They must value the benefits in order to complete the process of making their Shielding ability very reliable, as will be explained in Figure A, #6, below.

Since all promises are easy, short-term and voluntary, most participants can achieve the required state of mind to activate Mental Shields most of the time, even during this training process. We often encourage them to pay attention to the times in which they feel “absolutely sure” that they will keep a promise, because this is when a Mental Shield is in effect to help them keep their promises. We encourage them to notice the changes in how their minds work when they are “Shielded.”

The primary changes that we encourage them to notice are:

1. The essential change is a very high success rate of keeping their promises, as long (and only as long) as they are “Shielded” (feel absolutely sure that they will keep them).

2. Other changes include feeling much more comfortable while resisting the food desires they have promised not to have and much greater ease of resisting, although these are not essential.

The rules that promises should be easy, short-term and voluntary were designed to decrease resistance to making promises and to keep Shielders very comfortable. However, a person may not always be extremely comfortable keeping their promises, just like people are not always extremely comfortable keeping other Shielded behaviors (like paying every bill or feeding their families every day). Sometimes they count the minutes until a promise is over. But Shields do practically guarantee success at following behavior while making the person “as comfortable as possible,” usually very comfortable. The “boost” from the programmed mind usually makes them extremely comfortable, as in the above example of being able to resist the food of strangers in a restaurant. Even if they do occasionally regret making a promise, they only have to “stick it out” for a short time, and then are released, per the rules. But they do have to stick it out if they want to keep the benefits they are beginning to value. Most of the time, Shielders don't mind “sticking it out” to avoid losing the benefits.

We give incentives for Shielders to make numerous promises, such as to experience what it feels like to be “Shielded,” and to make easy, fast progress towards their goals. Most are almost immediately delighted to find that they can now, suddenly, easily succeed at behaviors that they could not easily succeed at, or do at all, before. For example, they now have the control to eat less food, like half of a bag of chips or just one cookie, instead of a whole bag. They can also “seal in” their eating intentions and prevent foreseen eating disasters with promises, as we encourage in the techniques (Figure A #7). In this way, Shielders begin to enjoy the benefits of making easy, steady progress towards losing weight, by making promises to do just a “little” better than they usually do. We encourage them to notice and appreciate these benefits.

Beginning weight loss Shielders are often told that some of the best promises for them to make are: Promises to wait until they are hungry before eating; Promises to cut ⅓rd to ½ of what they normally eat; Promises to fill their day with non-eating periods (an hour here, 10 minutes there); promises to do “just a little better” than they usually do in every situation; And promises to “Shield” their intentions “before” they change their minds. If they can't make these promises, they are encouraged to make easy promises that are as close as possible to them. (These are a few of the Shield Method techniques.)

Figure A, #6: Enable Shielders to form very reliable Mental Shields by teaching the “Locking Mechanism.” Up to this point, Shielders have been enjoying their ability to Shield, but the Mental Shields they are activating are not reliable. They are really only keeping their promises because they are easy to keep and because they “want” to. This is not enough! Eventually, they will Figure out that they don't have to keep their promises and will lose the “absolute sureness” required to activate Shields. For the Shield Method to be reliable, the Shielder must be able to reach the state of mind required to activate Mental Shields every time!

Therefore, one of the most important parts of this invention is the method which enables Shielders to remain “absolutely sure” that they must keep every promise that they make, so that they can always activate very strong, very reliable Mental Shields whenever they make a promise. We accomplish this by teaching and assisting them in learning the “Locking Mechanism” concept.

The “Locking Mechanism” (Figure B. #12-#18):

We teach Shielders that although they don't have to make any promise, once they do they can't even “intend” to break it. The reason is that if a Shielder allows himself to intend to break an occasional promise, then at every strong temptation he will have to ask himself, “Is this one of the promises I will allow myself to break?” Therefore, he can never feel “absolutely sure” that he will keep “any” promise. In other words, he can never rely on achieving the state of mind required to activate Mental Shields.

As diagrammed in Figure B, there are 3 components of the Locking Mechanism that enable the Shielder to achieve and maintain the “sureness” that he won't break promises. First, it is easy, and therefore “possible” to keep every promise (#12). Second, it is a true, unchangeable fact of reality that Shielders “must” intend to keep every promise to be able to activate Mental Shields consistently (#14). Third, because the Shielder highly values and desires the benefits that he has never had before for personal control applications (of being able to significantly increase success rates at achieving goals with greatly enhanced comfort, ease, self esteem and decreased stress), he is motivated to protect this ability (#16). As a result, most Shielders make up their minds not to make any promises unless they intend to keep them and therefore can enjoy all of the benefits of this system that they value (#18). As they get more and more “hooked” on the benefits, they become less and less likely to break promises, so the system automatically coils tighter and becomes stronger and more reliable.

Knowing that they absolutely can't intend to break promises, if they want to keep the benefits that they value, makes Shielders'“promise chains” nearly unbreakable and locks in success. Most Shielders can soon activate very strong and effective Mental Shields with the same success rate and comfort levels that other Mental Shields provide. Therefore, they can achieve a very high level of consistent successes and progress, while usually remaining very comfortable, any time and any place.

A Shielder who allows the possibility in his mind to break promises will eventually not be able to activate Mental Shields at all, per our observations. He will really only be keeping promises because they are easy to keep and he wants to. But when facing a temptation, he won't have the power of a Shield to protect him, and will have to use willpower to fight his mind in order to keep his promise. Therefore, his mind will be fighting him instead of helping him and he won't have any of the advantages and success rates that Mental Shields provide (he won't be any better off than before he started the Shield Method program). Intending to break promises also welcomes unwanted desires into the conscious mind.

It is often helpful to remind Shielders, at this point, that the rules make it very easy for them to keep all of their promises. It is even easier than covering every bank check they write. If they want the benefits of having a checking account, they “must” cover the checks they write. Similarly, if they want the benefits of being able to activate Mental Shields, they must simply keep the easy, short-term, voluntary promises that they make. This is usually very easy for most participants. The rules even excuse them for making “innocent” mistakes (breaking a promise because they forgot, etc.), something that their bank doesn't allow, and excuses them from keeping any promise that is or becomes unsafe or unhealthy.

As Shielders become more and more “sure” that they won't intend to break promises, they automatically “think twice” as they should before making any promise (just as they should before writing any check). Their new, strong superego influence is the chain of promises that they feel they will not break (theory).

Of course, Shielders do occasionally break promises, but not usually intentionally. If they intentionally break a promise, they must pay the consequences dictated by the rules (Figure A, #3: Rule, #7) and also risk putting their ability to form Mental Shields in total jeopardy, as described in the “Locking Mechanism” (Figure B), which is the last thing most Shielders want to do. Most Shielders come to value the benefits so much that they don't want to be without them even for 24 hours, the rule penalty for breaking a promise (Figure A #3: Rule #7). Note: The above “locking mechanism” may be taught any time before or after this point.

Figure A, #7: Teach and help participants learn the techniques and tips. Here we teach the techniques that I developed to use with this Method, while continuing to monitor their progress and give support. We have found these techniques to be very effective in helping participants stay in control even when their promises are over. The techniques are numerous and, in a preferred embodiment, are taught during a series of multiple individual lessons as participants continue making promises and gaining skill. Some or all of these techniques may be taught before or after this point, as desired. This is a preferred embodiment for weight loss. With or without obvious changes, these can be altered for other types of behavior goals. Other related tips and suggestions may be given, such as health tips and ways of doing things that we have found work best.

### Tips and Techniques for using Mental Shields for Weight Loss

(Same techniques may be used for other types of behavior with or without alterations.)

1. During the training period, Shielders go through a process in which they learn that they don't really want to eat without restriction, as they think they do. We teach them this through the use of a technique we call the “Pig Out” technique, which is as follows: We ask them to “Shield” to eat less of something they usually over eat for a short time (like 15 minutes) to experience eating less in the state of mind of being Shielded. After waiting the length of this promise, they may overeat or “pig out” as usual. At their next appointment, we ask them about the experience. Most Shielders soon learn that they wished they had stopped sooner.

2. In a continuation of the above promise, we ask the Shielder to repeat the experience, but this time, rather than over eating after their promise is over, we tell them to make a promise to have a small or limited additional amount for another limited or short period of time (like 15 minutes). This is called the “Poquito Mas” promise. After the term of this promise, they can either have as much as they want, or before or after the term of the promise they can make another Poquito Mas promise (a limited amount for a short or long period of time) or they can promise to have no more for a longer period of time. Most Shielders are thrilled with their ability to control and make choices about their behavior. By repeating this technique, most Shielders soon learn that they have the power to stop where they want and that they actually prefer to eat less food when they “Shield” the behavior.

3. A variation of this promise is the “Brake Shielding” promise. The Shielder promises to have a limited amount of something for a short period of time. Before or after the end of the promise, they make a promise to have a limited amount more for another limited or short period of time. This may be repeated as many times as desired. Like an 18 wheel truck going down a steep grade, they are “applying brakes” to avoid going out of control.

4. The above 3 techniques are effective for “don't” behaviors, such as “don't” eat so much. These techniques can be used in reverse for “do” behaviors, such as “do” exercise:

a. The “Delay Quantity” technique is reversed by asking the Shielder to promise to “do” a desirable behavior for a limited or short period of time to experience the behavior in the state of mind of being Shielded.

b. The “Poquito Mas” promise is reversed to “do” a limited additional amount of the desired behavior, rather than just stopping altogether.

c. The “Brake Shielding” promise is reversed to promise to “do” a little of the desired behavior for limited or short intervals, like an overheated truck going a little way up a steep hill and then stopping to rest or cool down as needed, but able to make steady progress towards it's goal.

5. We encourage Shielders to “set their own stopping point,” rather than continuing to their old stopping point, which, in some cases, is when they literally can't eat any more physically (a Physical Shield).

6. To stimulate desires to make promises, participants are often encouraged to pay attention to their behavior desires with the “What do you really want?” technique. For example, do they really want to eat the 18 cookies in the box they have just opened? Or would they rather protect themselves from too many with a promise?

7. One of the most important techniques is the “Try and Compare” technique. Shielders are often encouraged to try a behavior that is difficult for them by Shielding or promising to engage in the behavior for a short period of time, and to notice how much easier it is to accomplish in a “Shielded” state of mind. Then to compare their old behavior to the new experience. If they want to make the desirable behavior a habit, they are encouraged to make promises to repeat the new behavior until it becomes easy and automatic.

8. The Shield Method may encourage Shielders to use techniques to adopt the behaviors of successful role models in areas in which they wish to change or improve. For example, during the training process, Shielders who wish to lose weight may be encouraged to use their ability to Shield in a way that is patterned after the way “Naturally Thin Eaters” eat. These successful role models eat only when they are hungry, only until they are just full and then take “time off” from eating until the next meal when they are hungry again. Over-eaters generally eat whether or not they are hungry, eat beyond being full and often eat between formal meals.

9. The many “positive aspects” of following the naturally thin eater model are often pointed out to Shielders, such as being able to look forward to meals with a good appetite, rather than already being full; being able to eat anything they want at meals; being able to walk away from meals feeling good, rather than stuffed; being able to easily maintain a healthy weight; etc. The Naturally thin eater never has to feel uncomfortable, because they get to eat when they are hungry, and it is easy for the Shielder to emulate. They simply estimate when they will be hungry and make a promise to wait until then. Note: the positive aspects of eating this way cannot usually be achieved by over-eaters unless they are in the state of mind of being Shielded, like naturally thin eaters are.

10. However, some Shielders prefer to “Free Shield,” just cutting quantities and frequencies of eating as desired. This is fine, since most Shielders can easily cut hundreds to thousands of calories from their eating per day, just by Free Shielding. Every time they cut 3,500 calories, they can lose another pound, since a pound contains approximately 3,500 calories, although there are other important metabolic factors to consider.

11. Shielders are often taught to use the “Loving Parent” techniques, wherein they are encouraged to act as their own loving parent who controls what and when they eat. Parents want their children to enjoy food, but don't want them to eat too much or think about food all the time. Shielders are encouraged to make promises as responsibly as if they were their own guardians.

12. Similarly, Shielders may be taught techniques of “Passive Shielding.” For example, Shielders who have children may be taught techniques of Shielding them by imposing parental limits. Children are usually passively Shielded by their parents, which is how they can play for hours at a time without even thinking about food and often enjoy meals more than adults. But once children are allowed to decide what and how much food they can eat, they are no longer Shielded and can easily eat too much. Parents can be taught techniques that help Shield their children, as well as techniques for giving them the most valuable possessions of all—desirable permanent Shields.

13. “Family Rule” and “Buddy Plan” techniques may be taught. If family members, friends, co-workers, etc. can agree on a behavior plan, understanding and agreeing to the Shield Method concept that they cannot intend to break the behavior, this can mentally Shield them. However, they should formulate rules for innocently broken promises to avoid unnecessarily breaking their Shields. An additional rule for this application may include having a meeting if a rule is ever broken to correct problems or impose new voluntary penalties that are sufficient to maintain the state of mind required to activate Shields.

14. The “How much can you cut for 5 minutes?” technique. We have found that it is almost always better (and more healthy) to decrease the term of a promise rather than to increase the quantity of eating (or quantity of other undesirable behavior). For example, it's better to promise “No more than one cookie for 5 minutes” rather than “A whole box of cookies and nothing else for 2 days.” But the id portion of the mind will resist making restriction promises. So Shielders are encouraged to mentally consider how much they can cut for just 5 minutes. If they feel they can cut down to 1 cookie, we ask them to consider increasing the amount of time of the promise. Can they promise just 1 cookie for 15 minutes? How about just 1 cookie for 30 minutes. Whatever amount of time they feel comfortable with, we encourage them to Shield or promise. In fact, it is best to Shield the first easy promise they can think of and then try to improve it, to prevent changing their mind. As they soon learn, promising 1 cookie for 5 minutes “fools” their mind so they can easily remain in control. Most Shielders quickly learn to stay in control and lose their “fear of food” with this (and other) techniques.

15. The above promise can be used in reverse for “do” behaviors, by using the “Do just 5 minutes” technique. For example, it is often too difficult for the beginning Shielder to promise to do an hour of exercise, but it is easy for almost anyone to promise to do just 5 minutes. We have found that getting started is half the battle. If Shielders promise just 5 minutes of a desirable “do” activity every day, they often get involved and do much more, especially with the help of a support group or program. If 5 minutes is easy, we encourage them to consider whether or not they can promise to do 15 or 30. Or, before or while they are doing their exercise, they can “lock in” a promise to do 10 more minutes at any moment of strength.

16. A related promise is the “Ratchet Up” promise. Once the individual has promised to have only one cookie for 5 minutes, they may have a moment of strength during the 5 minutes to improve or “ratchet up” their promise and add more time. What often happens during the 5 minutes is that the person gets their mind on other things and forgets about having more cookies for a longer period of time than they expected. Just staying in control often makes them feel strong enough to make a better promise. Shielders are taught to take advantage of moments of strength to make better promises.

17. The id portion of the mind will resist long-term promises not to eat, since it desires to keep pleasure possibilities open. However, it is much easier for the Shielder to promise not to eat for 5 or 6 hours if they can promise to have a little snack during the 5 or 6 hours in case they want it or get too hungry. With the “Security Blanket” promise, the Shielder simply makes a promise like, “No eating for 5 hours, except I can have a cup of yogurt if I want it.” This makes it easier to make longer-term promises.

18. This brings us to the “Productivity” promise. The Shielder is encouraged to Shield or promise activities other than eating.

19. Shielders are often encouraged to take advantage of “Automatic Shields” for desirable behavior whenever possible. For example, a person who lives in a house in which they have to climb 2 dozen steps to get to their front door is “Shielded” to do stair-stepping, without having to make promises. Since the person feels “absolutely sure” that they have to climb the stairs, their mind helps them accomplish the exercise easily and comfortably, without even thinking of it as a chore. Other Automatic Shields include not buying a car, so you have to walk everywhere, and having a dog who “expects” to be walked every day.

20. Just having the ability to Shield “at will” can “reverse the activity of the mind.” Whereas before, an over-eater's mind would always “flirt” with ideas of engaging in worse behavior, now their minds are always “flirting” with ideas of making promises to engage in better behaviors. Shielders are encouraged to enhance this reversed state of mind by using a technique of “Flirting” with ideas, plans, visualizations and rationalizations of how they could do better, not worse.

21. Shielders may be taught the “Stop the Hand-To-Mouth Reflex” technique. Interrupting the “hand-to-mouth” reflex of eating, even for a few minutes, seems to decrease urges to eat more by signaling the brain to stop eating.

22. One of the most effective and easy Shielders techniques is called the “Promise Too Much,” technique. Shielders promise not to have any more than they think is “too much.” For example, when a pizza arrives, the Shielder may think they “should” promise to only have 2 pieces, but their id makes them hesitate. Yet they think that 4 pieces would be way too much to have, and promising to have no more than 4 pieces would be an easy promise for them to make. We encourage them to make this easy promise immediately, to avoid eating even more than 4 pieces feeling so bad about their behavior that they just keep eating! This technique prevents Shielders from eating even more than they think is too much, and can be used as leverage to improve the promise at a moment of strength. We often find that once they make the promise to have no more than the amount they think is “too much,” the fact that the “danger” has been eliminated makes them feel so relaxed and confident that they can easily improve the promise. This is also called the “Eliminate the Danger” technique.

23. We have a technique that Shielders can use to gently reduce their appetites called the “Eat Down Your Appetite” technique, wherein Shielders have what they want but less. When promised consistently, this can reduce or eliminate low blood sugar or diabetes by actually decreasing the size of the Islets of Langerhans of the pancreas which produce insulin, according to the Guytons Textbook of Medical Physiology. The person may no longer suffer symptoms of light-headedness, shakiness, fatigue or extreme hunger when they eat less, since their insulin response to eating will not overly deplete the blood of sugar.

24. Shielders are often encouraged to use the “Get Satisfied” promise. They learn that they can only truly get satisfied when they Shield a limited amount of food. Otherwise their mind will keep working for more and more food. Over eaters learn why they may have been eating without ever really getting satisfied and learn to enjoy “less food” more than “more.”

25. The “Have It Later” technique teaches Shielders that they don't have to have things they want immediately, and they don't have to deprive themselves of things they see and want when Shielded. They can buy or take things to enjoy later.

26. Shielders are often taught to take advantage of the protection that other kinds of Shields may give them. For example, the support group meeting utilizes strong “Social” and “Competition” Shields to help motivate Shielders. Not bringing especially tempting foods home can “physically” Shield a person while at home (however, most experienced Shielders can easily control their behavior at home, even with the strongest temptations in their kitchens).

27. Shielders are often taught the “Out of Sight, Out of Mind” promise. Putting away the food they have Shielded not to eat is a good policy to reduce forgetting that they promised not to have more and reduce temptations.

28. With the “Bite the Bullet” or “Just Make It” technique, Shielders are often encouraged to “just make” some promises that are difficult for them at a moment of strength for the purpose of experiencing new behaviors in the state of mind of being Shielded.

29. Shielders are often taught to “Shield their intentions” and “Shield their plans.”

30. The “Predict the Future” technique, is thinking ahead and making promises to prevent undesirable behaviors. When a Shielder thinks ahead, they can make promises to avoid behavior disasters.

31. One of my favorite techniques is the “3 more bites” promise because it works almost like magic. When a Shielder finds himself eating (like from a box of crackers) and can't seem to stop, he asks himself how many more crackers or “bites” he will allow himself to have and Shields it. This makes it easy for him to stop and helps the dragons of his mind prepare him to feel satisfied at the exact point he is Shielded to stop. Beginners usually can't promise to have just “3 more bites,” but they are encouraged to think of the lowest number of additional bites that they can comfortably promise. Even 10 more crackers is better than the whole box. Experienced Shielders can usually easily promise just 1 to 3 more.

32. There is one condition in which we actually encourage Shielders to break promises and pay the consequences. That is when they are having trouble maintaining the “sureness” that they will keep their promises. When a Shielder has trouble feeling sure that they will keep their promises, it usually just means that the consequences of breaking promises are not strong enough to Shield them. They should not try to force themselves to keep promises with willpower. Instead, we have them use the “Love It Or Lose It” technique, in which we actually encourage them to break a promise and pay the consequences, so that they can learn how important their ability to Shield is to them. This is sort of like asking a person to write a bad check so they can get arrested and lose their checking account and credit, to learn that they must cover their checks if they want to keep the benefits of having a checking account. It's exactly the same thing. The benefits are either worth it or they aren't. This usually fixes problems with sureness very quickly.

33. A technique called “Stop the Mind Battles” is taught to help decrease or eliminate conflicts between what a Shielder feels he “should” do and what he “wants” to do. By making a promise, the behavior decision is made and this stops the mind battle over what to do. Even making a short-term promise can alleviate the discomfort of a mind battle. Mind battles only happen when a person is not “Shielded.”

34. One of the most important techniques is the technique to “Establish New Habits.” The steps for establishing a new habits are to decide on a habit goal; Shield to “try” the behavior in the state of mind of being Shielded (with the mind working for the behavior instead of working against it); Compare the new behavior experience to the old behavior; Shield the desirable behavior regularly, with support until it becomes easy, automatic and preferred; a final (optional) stage “proves” that the habit is firmly established, if the person is actually revolted by their old behavior or would never go back to it.

35. When teaching people how to “Shield,” we may use a technique of telling them a fictional story about “The Dragons of the Mind,” who form the most powerful team known to man for obtaining desires. In a symbolic way, this story clearly describes the nearly infinite power of the mind and why it is almost impossible for a person to succeed at a behavior goal when they have to try to fight the dragons of their mind. It explains what is required to activate Mental Shields and how these Shields can put the power of the mind to work “for” a person's plans, rather than “against” them. The main characters of this story are Id the dragon (who represents the primitive mind and commands a host of Dragon workers), Judge Ego the Shield Master (who rules for or against desires) and the Superego Jury. Humanoids sit in the Superego Jury box who look like the Shielder's parents, church officials and people they look up to. The Superego Jury makes the individual feel good when they do what they feel they should and makes them feel bad when they don't.) Id the dragon is primitive in that he works for an individual's current desires without distinguishing between whether or not they are good or bad for him. Id can put the full power of the mind to work for desires, even when they are not very strong, and even cause desires to be intensified. For the first time, the Shield Method gives people a way to control or “Shield” Id for personal applications, and get their minds to work for positive desires and goals.

36. We have a number of “Fun Shielding Techniques” such as the “Mini Smorgasbord” technique, in which the Shielder has a small amount of all the foods they want. For example, he can have ⅙th of 6 donuts (instead of 6 donuts) for a variety. Note: only Shielded people have the control for this to be fun (only when they are in the “Shielded” state of mind of being “absolutely sure” that they won't have any more than they plan).

37. Shielders often automatically make their meals “special” in some way (set a place setting, use special plates, etc.), even though we don't require them to. This is difficult for people who have not gone through the program to understand, but can be easily explained by the following example: When a Shielder “Shields” to have only ½ cup of ice cream, so that they feel “absolutely sure” that they aren't going to have even one more bite for a few hours, they automatically find themselves carefully measuring the ice cream, putting it in a tulip glass with a fancy long spoon, setting it on a doily and planning to have it right when their favorite TV show starts. (Yes, they do lick the tulip glass, but they don't have even 1 more bite than they Shield!) Note: Years ago, scientists noticed that naturally thin eaters do things like this. They often set place settings before eating, wait until they sit down before starting to eat, arrange their food pleasantly, etc. The scientists theorized that if they could “train” over-eaters to imitate such behavior, they could change their habits. This “behavior modification” training does not work for most people (otherwise it would certainly be the treatment of choice for obesity). The scientists didn't realize is that it's difficult and even mentally painful for people to try to eat like this unless they are “Shielded,” like thin eaters are. Then the behavior is often an easy, natural result, as in the ice cream example, above.

38. Shielders may be taught the “Not hungry? Shield time!” technique, in which they ask themselves at any time “Am I hungry?” If not, they are encouraged to Shield not to eat for any amount of time that they can.

39. The “You Can Take It With You” technique is another fun technique, in which Shielders learn that they don't have to feel deprived. When they are Shielded and see a food they really want, like a pastry, they can take it and have it after their promise is over.

40. With the “Diluted drinking” technique, the Shielder learns to dilute caffeine and alcohol drinks to the extreme, turning 1 iced tea into 6, or 1 6 ounce glass of wine into 6 wine coolers. The Shield Method helps Shielders control alcohol consumption just as it helps them control their eating.

41. Shielders learn a technique called “Regulate Your Hunger.” It's always easy to estimate when they will be hungry after a promise is over and they can make a promise to wait until then. Shielders have the control to have a small snack to “tide them over” so that they can be hungry at any chosen time.

42. A fun technique or game, called “Spot The Shield” can be used to find out what Shields a person has. You can tell if a person has a Shield for a particular behavior by their habits and how their mind is working. For example, if you ask a person if they ever eat when they are not hungry and they respond “No” or “Not usually” the person is most likely a naturally thin eater and has a permanent “Healthy Eating Shield.” People who don't fight over food like wild animals in social situations have healthy “Permanent Social Shields” for this situation. A person who scowls when you bring up the idea of abusing drugs most likely has a healthy, desirable Permanent Shield against drug abuse. If a person isn't listening to reason, they are probably “Shielded for” a certain desire that their mind is suppressing the negative aspects and exaggerating the positive aspects of having. These “Spot The Shield” techniques may have important applications in fields such as criminal science and child rearing.

Many of the above techniques may sound familiar. This is because they are used extensively for other behavior applications, such as legal, financial, social etc. For example, when you write a contract to buy on an installment plan, you are using the “Brake Shielding” technique for “do” behaviors (technique #4). However, to my knowledge there has never been a way to use these techniques effectively and practically for personal control applications before.

Many of these techniques have even been used for weight loss before, such as the “Predict the Future” technique of thinking ahead and taking action to prevent undesirable behaviors (technique #30). But there has been no reliable way to ensure success in following them. Now, when a Shielder Shields this behavior, he is practically guaranteed to follow it. Contracts (another form of promises) have been tried for weight control, but have had very low rates of success and it is not possible to make or upgrade contracts instantly, any time and any place, as Shielders can do.

Therefore, the Shield Method is the “missing ingredient” we have needed to make all of these (and many other) techniques effective. Trying to use these techniques without utilizing Mental Shields has been like it would be if we had to “try” to pay our bills if we didn't feel “absolutely sure” that we had to.

Figure A, #8: Provide ongoing support and new applications. As participants continue with the program, we continue to monitor them and provide support and motivation. Our primary objectives are to encourage them to set and work on goals, prevent them from forgetting what they have learned and help them use the Shield Method consistently to the point of reaching their goals and changing their habits. They may reach a point that they no longer need to “Shield” behaviors because they prefer their new habits.

We have noticed in preliminary tests that when Shielders receive adequate support (such as a once a week appointment or meeting), most stop being out of control, lose their fear of food, have increased self esteem, change their behaviors dramatically and quickly start to develop new habits that they prefer. Weight loss is a side effect of the control. Personal support seems to give the best results. With personal counseling or support group, it is not unusual for Shielders to be able to decrease their food intake by ⅓rd or ½ with little effort. Support is important because the id portion of the mind will soon begin to resist the idea of making promises. With support, we have noticed that Shielders continue making promises consistently until their new behavior becomes easy, automatic and preferred, at which time they may no longer need to make promises for certain behaviors.

Inexpensive support group meetings are highly effective, but any other type of support (personal, non-personal, interactive computer or device, etc.) that can help to Shielders set goals, continue making promises, increase their skill and prevent them from forgetting what they have learned will increase their ability to succeed.

At the end of the teaching process, Shielders often can't believe how much they've changed in such a short time and so gently! Most can do better than before in almost any situation and can rapidly regain control any time they start going out of control. We have noticed that after awhile, the number of strong urges to binge or overeat may decrease considerably or almost completely stop. I believe this is due to the establishment of a new, permanent “Mental Control Shield.” The person feels “absolutely sure” that they can maintain control, so the ego portion of the mind forms a protective Mental Shield against many id desires, so that when the id sends a desire into the consciousness, the ego can deflect it. The id is persistent, but not foolish. It won't work for “impossible” desires, so it eventually stops sending so many desires.

New habit development is the greatest achievement of the Shield Method. I believe the Shield Method is the first program that really can change habits, dramatically, very quickly and permanently. No other previous method has been able to so easily, quickly and effectively promote new habit development. Most doctors and scientists now agree that establishing improved behavior habits is the only sure way for people to be able to lose weight and maintain their weight loss long-term. The fact that habits are preferred is a great bonus of the Shield Method, since preferred habits are more likely to last a lifetime!

We may encourage Shielders to enroll in other programs that we may offer, such as a substance abuse, exercise or relationship program (understanding and using Mental Shields can help with personal relationships), etc.

Figure A, #9: Unique promotional themes, slogans, floor plan, etc. Unique advertising and promotion are geared to orient and educate potential clients to understand enough about Mental Shields and the Shield Method to interest them in programs that may benefit them. The business method may also include ongoing research to find and use new and ways of utilizing Mental Shields and applications resulting therefrom.

A unique advertising and office decoration theme based on Shields and dragons, medieval or other, may be used. The dragon theme originates from a story that is told during the teaching process of the Shield Method, about imaginary dragons who live in the mind, to more easily teach complex concepts of how the mind works. We may utilize characters and elements of the story, in advertising and in other ways to develop strong associations, in the public mind, with the Shield Method.

In addition, due to the fact that the Shield Method gives most people much more “willpower” than they have ever had, we often use the term “Super Willpower” as a slogan on business cards, stationary, web site, teaching and other materials, etc. A unique aspect of the office floor plan is the use of conference rooms with conference tables (or other tables) for support group meetings whenever possible. This is different from traditional support-group meetings which are usually held in open classrooms or meeting rooms without conference tables.

Another unique business method may include “chanting answers” to help fix information in the mind of Shielders. For example, at a meeting the instructor may call out or chant like a drill sergeant, “What happens when you don't Shield to do something you don't have to do? The members may then reply in unison, “It isn't likely to get done!” These may be musical chants and may be used in exercise meetings.

### CONCLUSIONS, RAMIFICATIONS AND SCOPE

The Shield Method enables people to withstand strong urges and desires for short-term desires so that they can obtain their long-term goals. It can give consistently higher levels of success, control, ease, comfort and self esteem while decreasing stress. It can establish new permanent habits. Therefore, the Shield Method is an important advancement which can dramatically reduce obesity and other behavior-related problems, illnesses an deaths worldwide.

Although the description above contains many specificity's, these should not be construed as limiting the scope of the invention but as merely providing illustrations of some of the presently preferred embodiments of this invention. Many additional applications can help people utilize the benefits of the Shield Method. Some of these are listed, below:

1. Embodiments for substance abuse control, such as for smoking, alcohol or drug use could be similar to the weight control application of this specification. Steps could easily be modified so that the amount and frequency use of these substances would be reduced and eventually eliminated, if desired.

2. Embodiments for “do” behaviors, such as to exercise consistently or complete a projects, would also be similar to the weight control application of this specification. The Shield Method is easily be modified so that the amount and frequency of these desired behaviors is increased.

3. Possibilities for child rearing applications are numerous. Overweigh children can learn the method to lose weight and/or gain more personal control. Parents can use the system to better understand their children and learn more effective ways to control them, and establish better behavior Shields in them.

4. Numerous embodiments are foreseen in the field of psychology. With modifications, Shield Method programs could help treat addictions and many psychological disorders, such as obsessive and/or compulsive disorders. The Shield Method can give people a way to control their behaviors and decrease the frequency and intensity of their repetitive or other undesirable behaviors. It can enable people to experience new behaviors in a more non-threatening and comfortable way so that they can more easily learn to prefer better behaviors and change their habits. The Shield Method significantly decreases stress while increasing control and feelings of self esteem, which are extremely important in the field of psychology.

5. Shield Method programs may benefit people in the teaching and people management fields. It can provide people more effective ways of understanding and controlling behaviors, stress, increasing ease of tasks, etc.

6. Shield Method programs could be used to increase group performance, such as to reach goals set by a company or group.

7. Relationship improvement (family, spouse, other).

8. The Shield Method can have very important uses in the field of criminal science. Offenders have never had a way to control their behaviors other than with willpower, which gives very low success rates. Shield Method programs could help people better understand the criminal mind, provide more effective ways of changing behaviors, etc.

9. Since the Shield Method can change habits permanently, many previous systems that weren't very effective may now be effective. For example, weight loss drugs or clinics which can take weight off more rapidly may now work, because people have changed their eating habits and won't regain the weight afterwards. This is supported by medical science. According to Guytons Textbook of Medical Physiology, the body's fat stores are maintained like a bank account. After a person gains the weight, it is like they have a large balance. Then, they only have to pay the monthly maintenance fee in order to maintain the balance. In other words, an overweight person does not have to overeat to maintain their weight. Doctors now frown on quick weight-loss programs before, because habits weren't changed and patients were likely to gain the weight back as soon as they went back to their old eating habits. Shielders who change their habits may be expected to keep the weight off for good on one of these programs.

10. A camp or retreat which would teach the Shield Method and offer rapid weight loss and/or other beneficial services simultaneously (such as to teach health concepts and increase metabolic rates) would be ideal.

11. Computer programs, which can teach, test and/or motivate people in the use of the Method.

12. Computerized (or other) games or practice devices that help participants increase their skill at forming and using Mental Shields.

13. Computerized (or other) systems which can be used as a “physical activation signal,” remind participants of the promises they have made, when to make a promise, the rules, techniques, motivational or educational information.

14. The “ShieldMaster.” Any device (computerized or other) that can give behavior commands or choices that the person feels they must follow (like a slave must follow the instructions of a master, except voluntary) to result in the required state of mind to activate Mental Shields. This could be programmed custom for the individual's goals and would have the advantage that the person would not have to make promises. The rules and techniques could also be programmed in the machine. Imagine a future where the person sitting across from you at lunch is interrupted, not by a pager or cell phone, but a call command from his ShieldMaster, and have to get up and follow the command he is given!

15. Computerized (or other) device that can produce the “sureness” state of mind required to activate Mental Shields.

16. Alternative embodiments which enable longer and/or more difficult promises, such as for advanced Shielders.

17. The Shield Method may be used in reverse for “reverse psychology” applications, such as to have a person experience a negative behavior with which to compare a positive one. This application is foreseen to be useful for people suffering from depression or to help people understand the negative aspects of behaviors whenever there may be a beneficial use.

18. The preferred “naturally thin eater” model is optional. Any other model of eating can be used in the embodiment for weight loss.

19. Models (as above) can be used for other embodiment uses for the Shield Method, as explained in the specification.

20. Many steps of the preferred embodiment of learning the Shield Method may be eliminated. For example, people can discover the benefits, uses and their lack of Shields without being specifically taught. Also, new permanent Mental Shields do not have to be established for positive results.

21. The Shield Method allows “new use” of all of the “prior art” techniques and uses listed in this application. When coupled with the method of this invention, they are suddenly much more functional, effective and give a dramatically different and improved result.

I claim:

1. A method of teaching an individual to program a mind thereof to follow a voluntary personal behavior plan that helps to achieve a predetermined goal, comprising:
a. providing and teaching a set of rules and techniques that said individual uses to select and follow said personal behavior plan which is within said individual's ability to follow and which results in progress towards said predetermined goal;
b. encouraging said individual to mentally select said personal behavior plan, abiding by said rules and considering said techniques;
c. encouraging said individual to make a mental promise to follow said selected personal behavior plan; and
d. providing means of incentive for said individual to keep said promise that helps said individual withstand considerable temptations to do otherwise,
whereby, when said individual makes said mental promise, said individual reaches a state of mind which fully intends to follow said personal behavior plan, which programs or alters activities of said mind to help said individual succeed at keeping said personal behavior plan and reaching said personal goal.

2. The method of claim 1, further including a rules that said personal behavior plan must be easy for said individual to follow.

3. The method of claim 1, further including a rules that said personal behavior plan must be safe for said individual to follow.

4. The method of claim 1, further including a rules that said personal behavior plan promise must have a term assigned to it.

5. The method of claim 4, wherein said term of said personal behavior plan promise is from less than 1 minute to 6 hours.

6. The method of claim 5, wherein an exception may be made in the said term of said behavior plan promise in which said term may be over 6 hours.

7. The method of claim 4, further including that said term assigned to said promise is not required to be an exact time, but can be the length of time until or after a certain pre-designated event occurs, as said selected by said individual and said promised.

8. The method of claim 4, further including that said term of said personal behavior plan promise is longer than 6 hours.

9. The method of claim 1, further including a rule that said individual may make said promises any time, as desired.

10. The method of claim 9, wherein an exception may be made in said rule that said individual may make said promise any time whereby the privilege to make said promises is revoked as a penalty of said rules.

11. The method of claim 1, further including a rule that said individual may make a plurality of said promises which may be in effect at the same time.

12. The method of claim 1, further including a rule that said individual may increase the term of said promise, as desired, by making an additional said promise to do so before the end of the term of said promise.

13. The method of claim 1, further including a rule that said individual may upgrade said promise, as desired, by making an additional said promise which is of equal or better value than said promise, said additional said promise shall replace said promise.

14. The method of claim 1, further including a rule that said individual is completely relieved of following said personal behavior after keeping said promise.

15. The method of claim 1, further including a rule that said individual is completely relieved of following said personal behavior plan if it becomes unsafe or unhealthy to follow said behavior plan.

16. The method of claim 1, further including a rule that said individual cannot make said promise unless they desire to.

17. The method of claim 1, further including a rule that said indidual must keep said promise to avoid one or more consequence.

18. The method of claim 17, further including that a said consequence is the voluntary forfeiture of the right to make any more said promises for a certain term.

19. The method of claim 17, further including that a said consequence is a deterioration or loss of the ability to said reach said state of mind which fully intends to follow said personal behavior plan.

20. The method of claim 17, further including a rule that said individual is relieved of said consequence(s) if they innocently break said promise by forgetting it.
